(19) United States
(12) Patent Application Publication
(10) Pub. No.: US 2026/0291139 A1
(43) Pub. Date: Sep. 24, 2026

(54) IMPROVED ELECTRIC CONNECTOR

(71) Applicant: ITALWATT S.R.L., LEINI (TO) (IT)

(72) Inventor: Luca Luigi Ciaudano, LEINI (TO) (IT)

(73) Assignee: ITALWATT S.R.L., LEINI (TO) (IT)

(21) Appl. No.: 19/476,529

(22) PCT Filed: Jan. 25, 2024
(86) PCT No.: PCT/IB2024/050711

§ 371 Date: Oct. 17, 2025

(30) Foreign Application Priority Data
May 25, 2023 (IT) 102023000010623

(51) Int. Cl. H01R 13/6587; H01R 12/70; H01R 12/71; H01R 12/75; H01R 13/623; H01R 24/86

(52) U.S. Cl. CPC H01R 13/6587; H01R 12/7047; H01R 12/716; H01R 12/75; H01R 13/623; H01R 24/86; H01R 2201/26

(57) ABSTRACT

Connector for electrically connecting an electronic circuit board and wiring cables of a vehicle, comprising a main body extending along a longitudinal axis and provided with a first connection portion configured to cooperate with the wiring cables and a second connection portion configured to cooperate in contact with the electronic circuit board and a plurality of pins provided with a first end configured to electrically cooperate with the electronic circuit board and a second end configured to electrically cooperate with the wiring cables, the plurality of pins being carried by the main body electrically isolated from it, the connector comprising shielding means configured to radially surround the second connection portion with respect to the axis and to cooperate in contact with the electronic circuit board when the connector, in use, is fixed thereto, so as to prevent the transmission of electromagnetic radiation towards the pins.

### CROSS-REFERENCE TO RELATED APPLICATIONS

This Patent Application claims priority from Italian Patent Application No. 102023000010623 filed on May 25, 2023, the entire disclosure of which is incorporated herein by reference.

### TECHNICAL FIELD

The invention relates to a connector, in particular an electric connector.

The invention is preferably, though not exclusively applied to wirings for vehicles for military use in compliance with the standards enforced for electrical interfacing. Hereinafter reference will be made to this application by mere way of example.

### KNOWN STATE OF THE ART

Vehicles, such as military vehicles, comprise electronic systems provided with at least one electronic unit electrically connected to one or more electronic devices, such as sensor means or radio-communication systems.

The aforesaid connection is obtained by means of wirings, which connect the electronic devices to the electronic unit. Said wirings are connected, in particular, to the electronic unit by means of a connector.

Said connectors comprise conductive elements, such as pins, arranged according to a predefined geometry around the axis of the connector and configured to electrically permit the connection between a unit containing an electronic circuit board and the aforesaid wirings.

The pins are carried by a support body, which is fixed to the electronic circuit board and, if necessary, to other vehicle support portions by means of through holes and relative fixing elements, such as screws.

The aforesaid structure of the connector, however, does not avoid a series of problems in terms of electromagnetic interference and risk of lack of protection from dust and water, which are unacceptable in the military industry.

First of all, the presence of the pins for the connection to the electronic circuit board inside the unit allows for the transmission of interferences into the electronic circuit board.

Therefore, shielding circuits are provided, which are designed to neutralize the interferences due to the pins and are arranged close to the connection thereof on the electronic circuit board.

Furthermore, the through holes, which allow the electronic circuit board to be fixed, further allow interfering signals as well as dirt and water to enter.

Therefore, a connector is needed, which is capable of solving the aforesaid interference and sealing problems affecting known connectors.

The object of the invention is to fulfil the needs discussed above in an optimized and economic fashion.

### SUMMARY OF THE INVENTION

The aforesaid object is reached by a connector according to the appended claims.

### BRIEF DESCRIPTION OF THE DRAWINGS

The invention will be best understood upon perusal of the following detailed description of a preferred embodiment, which is provided by way of non-limiting example, with reference to the accompanying drawings, wherein:

FIGS. 1A-1B are schematic views, namely a side view and a sectional view in a longitudinal direction, respectively, of a first embodiment of the connector according to the invention;

FIGS. 2A-2B are schematic views, namely a side view and a sectional view in a longitudinal direction, respectively, of a first embodiment of the connector according to the invention; and

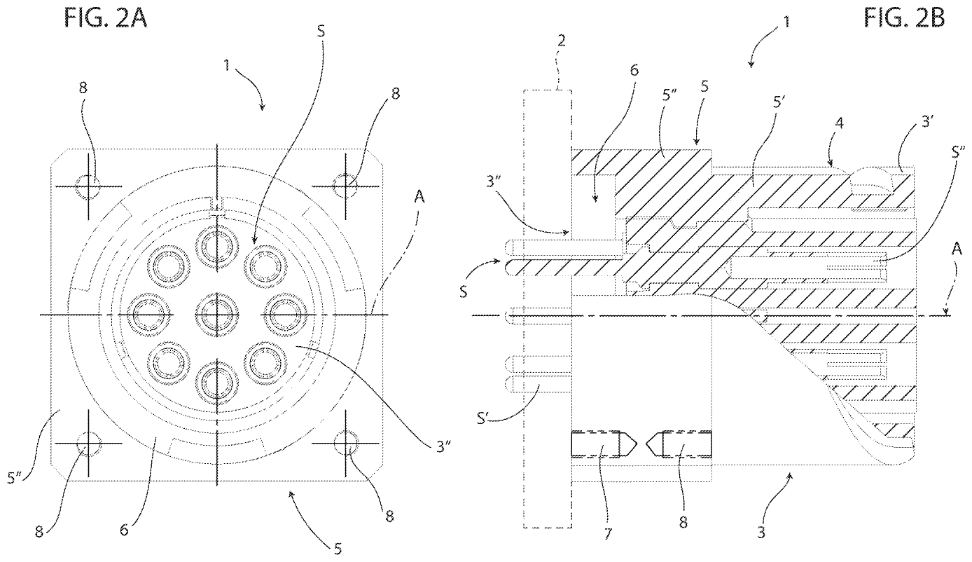

FIGS. 3A-3B are schematic views, namely a side view and a sectional view in a longitudinal direction, respectively, of a first embodiment of the connector according to the invention.

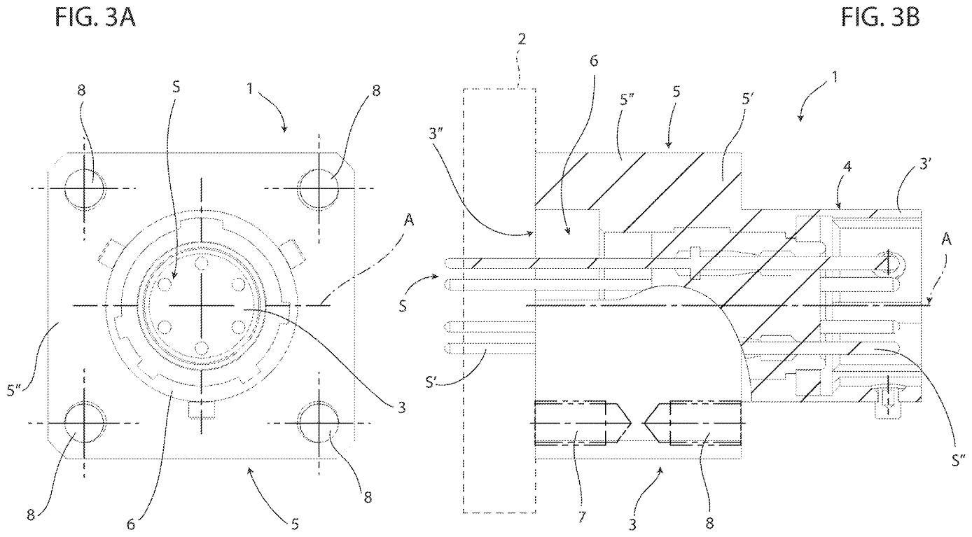

### DETAILED DESCRIPTION OF THE INVENTION

In the accompanying figures, number 1 indicates a connector for military use configured to electrically connect an electronic circuit board 2 to respective wiring cables (not shown).

In particular, the connector 1 comprises a main body 3 comprising a first connection portion 3′ and a second connection portion opposite one another along a longitudinal axis A, along which the main body 3 extends. In detail, the main body 3 is manufactured according to MIL standards and is sized so that it can be interfaced with any kind of required electrical connection.

The connection portions 3′, 3″ are advantageously connected to one another in a rigid manner, in particular they are manufactured as one single piece.

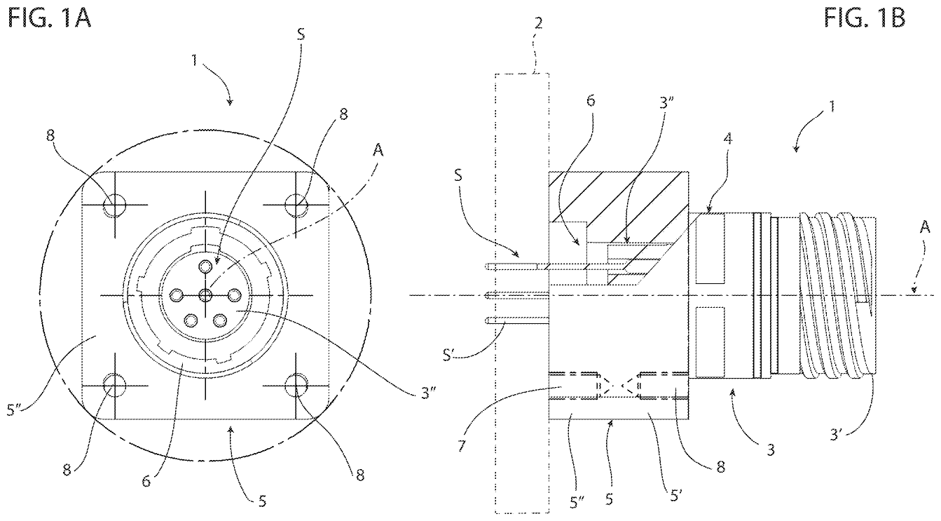

In detail, the first connection portion 3′ is configured to be connected to a wiring system provided with a plurality of cables, for example by means of a shape coupling, for instance a threaded one as shown, in particular, in FIG. 1, which shows the connector 1 according to the invention in its entirety.

In particular, the second connection portion 3″ is configured to cooperate in contact with the electronic circuit board 2 and comprises a plurality of pins S configured to be inserted into the electronic circuit board 2 and to electrically cooperate with it.

In particular, the pins S are arranged with a predefined geometry around the axis A depending on the needs for the connection between the electronic circuit board 2 and the wirings by means of the connector 1.

In detail, the pins S define a first end S′ configured to cooperate with the electronic circuit board 2 and a second end S″ opposite the first one along the longitudinal axis A and electrically connected to the aforesaid wiring (not shown).

In particular, the connection portion 3″ comprises a support element for the pins S.

Preferably, as shown in all embodiments, the main body 3 is manufactured as a hollow tubular body and the pins s are carried by a support element accommodated on the inside of the main body 3 and manufactured in a separate manner. The pins S are advantageously carried by the support element, going through the latter along the axis A.

In particular, the main body 3 is made of a metal material and the support element for the pins S is made of an electrically non-conductive material. In particular, the main body 3 is made of aluminium.

Advantageously, the first and the second connection portion 3′, 3″ are visually separated from one another by indication means 4, manufactured as an annular band obtained on the outside of the main body 3 and configured to provide information on the type of connector.

In particular, the indication means 4 are obtained by means of a groove made on the outer surface of the main body 3 and coloured or housing a coloured ring. The colour can be associated with a specific type of connector.

According to the invention, the connector 3 comprises shielding means 5 configured to radially surround the second connection portion 3′ and to cooperate in contact with said circuit board, when said connector, in use, is fixed thereto, so as to forbid the transmission of electromagnetic radiations to said pins S′.

In particular, said shielding means 5 comprise a metal material portion, thus generating, around said connection portion 3″, a Faraday cage, which leads electromagnetic radiations to the main body 3, thus preventing them from being transmitted to the pins 3.

In particular, the shielding means 5 comprise said metal portion, which is manufactured as one single piece together with the main body 3.

The shielding means 5 advantageously comprise a main portion 5′ radially extending from the second connection portion 3″ with respect to the longitudinal axis A and a projecting portion 5″ axially extending starting from the main portion 5′ on the side opposite the first connection portion 3′, i. e. towards the second connection portion 3″.

In particular, the projecting portion 5″ radially delimits the first portion S′ of the pins S, thus radially delimiting a chamber 6, which, is use, is axially delimited, on one side, by the electronic circuit board 2 and, on the other side, by the second connection portion 3″, in particular by the support element for the pins S.

The connector 1 advantageously defines a plurality of first dead holes 7 configured to permit the insertion of fixing means (not shown) configured to allow the connector 1 to be connected to the electronic circuit board 2.

In particular, said first plurality of dead holes 7 are obtained in the projecting portion 5″ and are made with an axis parallel to the axis A.

The projecting portion 5″ advantageously has a substantially polygonal shape, centred on the axis A, around the body 3 and, in the appended figures, a quadrangular, in particular square shape. The first dead holes 7 are preferably obtained in the area of the vertices of the shape of the projecting portion 5″.

The connector 1 preferably defines a plurality of second dead holes 8 configured to permit the insertion of fixing means (not shown) configured to allow the connector 1 to be connected to portions of inner walls of a box containing the electronic circuit board 2.

The projecting portion 5″ advantageously has a substantially polygonal shape, centred on the axis A, and, in the appended figures, a quadrangular, in particular square shape. The second dead holes 8 are preferably obtained in the area of the vertices of the shape of the projecting portion 5″.

In particular, said second plurality of dead holes 8 are obtained in the projecting portion 5″ and are made with an axis parallel to the axis A and, more in detail, they are coaxial to the first plurality of dead holes 7.

In the embodiments of FIG. 1A/1B, 2A/2B, 3A/3B, the parts described above are similar, but there is a difference in the relative dimensions of the first and the second connection portion 3′, 3″ and of the shielding means 5 as well as in the number and in the arrangements of the pins S.

In particular, said dimensions change depending on the type of connector on the number of cables needed, on the number of available pins S and on the thickness of the screws to be used on the electronic circuit board 2.

The operation of the embodiment of the connector according to the invention described above will be disclosed below.

Once in use, like in the configurations of FIG. 1A/2A73A, the connector 1 allows, through the pins S, the electronic circuit board 2 and the wiring to be electrically connected to one another. Once connected by means of the fixing means in the holes 7, the second connection portion is in contact with the electronic circuit board 2, thus isolating the first portion S′ of the pins S in the space 6, which is separated from the outside by the shielding means 5, which act as electromagnetic “transmission” to the main body 3 of the connector 1, which can transmit to other vehicle elements, for instance connected through the second holes 8.

Owing to the above, the advantages of a connector according to the invention are evident.

Thanks to the shielding means disclosed herein, the pins can electromagnetically be isolated against radiated interferences coming from the environment. In this way, besides the possibility of using electronic components on board the circuit board, the electromagnetic requirements established by military standards can be better respected.

In addition, thanks to the use of dead connection holes between the connector and the electronic circuit board or the vehicle portions, water and dirt, as well as further interfering radiations, are prevented from reaching the pins of the connector.

Moreover, thanks to the projecting portion and to the space accommodating the ends of the pins, the isolation is further improved thanks to the empty space obtained between the shielding means and the electronic circuit board.

Furthermore, in case the shielding means are manufactured as one single piece together with the main body of the connector, spaces and costs are significantly reduced.

In addition, the electrical conductivity of the body 3, which is mandatory to fulfil military requirements, is further improved.

Finally, the connector according to the invention can clearly be subjected to changes and variants, which, though, do not go beyond the scope of protection set forth in the appended claims.

As widely shown, the shapes and types of portions shown herein can change based on design needs.

1. Connector (1) for electrically connecting an electronic circuit board (2) and wiring cables of a vehicle, said connector (1) comprising a main body (3) extending along a longitudinal axis (A) and provided with a first connection portion (3′) configured to cooperate with said wiring cables and a second connection portion (3″) configured to cooperate in contact with said electronic circuit board, said connector (1) comprising a plurality of pins(S) provided with a first end (S′) configured to electrically cooperate with said electronic circuit board (2) and a second end (S″) configured to electrically cooperate with said wiring cables, said plurality of pins(S) being carried by said main body (3) electrically isolated from it, said connector (1) comprising shielding means (5) configured to radially surround said second connection portion (3″) with respect to said axis (A) and to cooperate in contact with said electronic circuit board (2) when said connector (1), in use, is fixed thereto, so as to prevent the transmission of electromagnetic radiation towards said pins (S′).
wherein said shielding means (5) comprise a main portion (5′) radially extending around said second connection portion (3″) with respect to said longitudinal axis (A) and a projecting portion (5″) axially extending starting from said main portion (5′) on the side opposite said first connection portion (3′), said projecting portion (5″) radially delimiting said first portion (S′) of said pins(S) so as to radially isolate a chamber (6), which, in use, is axially delimited, on one side, by said electronic circuit board (2) and, on the other side, by said second connection portion (3″).

2. Connector according to claim 1, wherein said shielding means (5) comprise a portion made of metallic material.

3. Connector according to claim 1, wherein said shielding means (5) comprise a polygonal-shaped portion centred on said axis (A) around said main body (3).

4. Connector according to claim 1, wherein said shielding means (5) are made in one piece with said main body (3).

5. Connector according to claim 1, further comprising a first plurality of dead holes (7) configured to allow for the connection, by means of fixing means, to said electronic circuit board (2).

6. Connector according to claim 5, wherein said first plurality of dead holes (7) has an axis parallel to said longitudinal axis (A).

7. Connector according to claim 5, wherein said shielding means (5) comprise a polygonal-shaped portion centred on said axis (A) around said main body (3, wherein said first plurality of dead holes (7) is made close to the vertices of said polygonal shape.

8. Connector according to claim 5, further comprising a second plurality of dead holes (8) configured to allow for the connection, by means of fixing means, to a housing portion of said electronic circuit board (2).

9. Connector according to claim 8, wherein said second plurality of dead holes (8) has an axis parallel to said longitudinal axis (A).

10. Connector according to claim 1, wherein said first and second pluralities of dead holes (7, 8) are coaxial to one another.

11. Connector according to claim 1, wherein said shielding means (5) are made of aluminium.

12. System comprising an electronic circuit board (2) and wiring cables and a connector (1) according to claim 1 connecting said electronic circuit board (2) and said wiring cables via said pins(S).

13. Vehicle comprising a system according to claim 12.
